(19) United States
(12) Patent Application Publication
(10) Pub. No.: US 2003/0169267 A1
(43) Pub. Date: Sep. 11, 2003

(54) Apparatus for reusing lighted vertex data in a computer graphics system

(76) Inventor: Chung-Yen Lu, Taipei (TW)

Correspondence Address: BIRCH STEWART KOLASCH & BIRCH, PO BOX 747, FALLS CHURCH, VA, 22040-0747, US

(21) Appl. No.: 10/087,760

(22) Filed: Mar. 5, 2002

(51) Int. Cl. G09G 5/00

(52) U.S. Cl. 345/581

(57) ABSTRACT

An apparatus for reusing lighted vertex data in a computer graphics system. The disclosed apparatus includes a storage area having entries that are employed to store lighted vertex indices. The apparatus has a number of comparators each of which compares respective content of the corresponding entry with a presently received vertex index to determine whether they are the same. It also includes an encoder, a counter and a multiplexer. In response to output of the comparators, the encoder reports a hit value and produces an address dedicated to the entry storing the lighted vertex index that is the same as the received vertex index. The counter increases an update pointer by one when the hit value is not indicative of a hit status. Based on the hit value, the multiplexer selectively outputs the address or the update pointer as a reference position.

### FIELD OF THE INVENTION

The present invention relates generally to computer graphics systems and, in particular, to a computer graphics system utilizing a geometry accelerator incorporating a graphics management module to achieve improved performance.

### BACKGROUND OF THE INVENTION

Computer graphics systems are commonly used for displaying graphical representations of objects on a two-dimensional display screen. Current computer graphics systems can provide highly detailed representations and are used in a variety of applications.

In typical computer graphics systems, an object to be represented on the display screen is broken down into a plurality of graphics primitives. Primitives are basic components of a graphics picture and may include points, lines, and polygons, such as triangles or quadrilaterals. Typically, a hardware/software scheme is implemented to render, or draw, on the two-dimensional display screen, the graphics primitives that represent the view of one or more objects being represented on the screen.

Generally, the primitives that define the three-dimensional object to be rendered are provided from a host computer, which defines each primitive in terms of primitive data. For example, when the primitive is a triangle, the host computer may define the primitive in terms of the X, Y, Z coordinates of its vertices, as well as in terms of the red, green, blue and alpha (R, G, B and α) color values of each vertex. Alpha is a transparency value. Rendering hardware interpolates the primitive data to compute the display screen pixels that represent each primitive, and the R, G, B and α values for each pixel.

A computer graphics system typically includes a geometry accelerator, a rasterizer, and a frame buffer. The system may also include texture mapping hardware. The geometry accelerator receives primitive data from the host computer that defines the primitives that make up the view to be displayed. The geometry accelerator performs transformation on the primitive data and may also perform such functions as lighting, clipping, and plane equation calculation for each primitive. The output of the geometry accelerator, referred to as rendering data, is used by the rasterizer and the texture mapping hardware to generate final screen coordinate and color data for each pixel in each primitive. The pixel data from the rasterizer and the pixel data from the texture mapping hardware, if available, are combined and stored in the frame buffer for display on the video display screen.

The basic components of a conventional geometry accelerator are shown in FIG. 1. The geometry accelerator 102 includes a fetch unit 110, a transform engine 120 and a lighting engine 130. The fetch unit 110 receives vertex data VTD in accordance with a vertex index IDX by sending a data request REQ. The transform engine 120 receives the primitive vertex data from the fetch unit 110 over bus 112 and performs transformations on the vertex data, such as rotation and translation of the image space defined by vertex data. The lighting engine 130 receives the transformed vertex data via bus 122 and calculates the final colors of the vertices of the primitives based on the vertex data and based on lighting conditions. As depicted, the lighting engine 130 outputs the lighted vertex data over bus 132 for further processing.

As stated above, the operations of the geometry accelerator are computationally very intense because of the large volume of data transferred between the host computer and the geometry accelerator and because of the fact the geometry accelerator normally is required to perform several hundred million floating point calculations per second. To speed up operation of computer graphics systems, it is common to implement special-purpose circuitry dedicated to transformations and lighting operations. Nonetheless, the need exists for further improvements in performance. In particular, the need exists for reduction of these computations performed by the geometry accelerator.

Accordingly, it is desired to provide an apparatus for reusing lighted vertex data in a computer graphics system. This, in turn, results in minimizing the overall amount of vertex data that must be processed by the geometry accelerator.

### SUMMARY OF THE INVENTION

The present invention is generally directed to an apparatus for reusing lighted vertex data in a computer graphics system. In accordance with one aspect of the invention, the apparatus includes a storage area having a plurality of entries each of which is used to store a lighted vertex index. It also includes a plurality of comparators each of which compares respective content of the corresponding entry with a presently received vertex index to determine whether they are the same. An encoder is included and adapted to report a hit value and to produce an address in response to output of the comparators. When one of the comparators determines that the content of the corresponding entry and the received vertex index are the same, the hit value reported from the encoder is indicative of a hit status. Further, the address is dedicated to the entry storing the lighted vertex index that is the same as the received vertex index. The apparatus also has a counter for increasing an update pointer by one when the hit value is not indicative of a hit status. Finally, in response to the hit value, a multiplexer is provided to selectively output the address as a reference position if the hit value is indicative of the hit status. Conversely, the multiplexer selectively outputs the update pointer as the reference position if the hit value is not indicative of the hit status.

In accordance with another aspect of the invention, a graphics management module is provided for use in a geometry accelerator of a computer graphics system. This module includes a reference generator, a reference queue, a data buffer and a data manager. The reference generator receives a vertex index and provides a hit value and a reference position. The reference queue is used to store the hit value and the reference position. The data buffer is configured to store lighted vertex data processed by the geometry accelerator. The data manager fetches the hit value and the reference position from the reference queue. The data manager also instructs the data buffer to retrieve and output the lighted vertex data according to the reference position when the hit value indicates that the lighted vertex data associated with the received vertex index is previously stored in the data buffer. Otherwise, it instructs the data buffer to store the lighted vertex data processed by the geometry accelerator according to the reference position when the hit value indicates that the lighted vertex data associated with the received vertex index cannot be found in the data buffer.

### BRIEF DESCRIPTION OF THE DRAWINGS

The present invention will be described by way of exemplary embodiments, but not limitations, illustrated in the accompanying drawings in which like references denote similar elements, and in which:

FIG. 1 is a block diagram of a geometry accelerator in accordance with the prior art;

FIG. 2 is a block diagram of a geometry accelerator incorporating principal functional components of the invention;

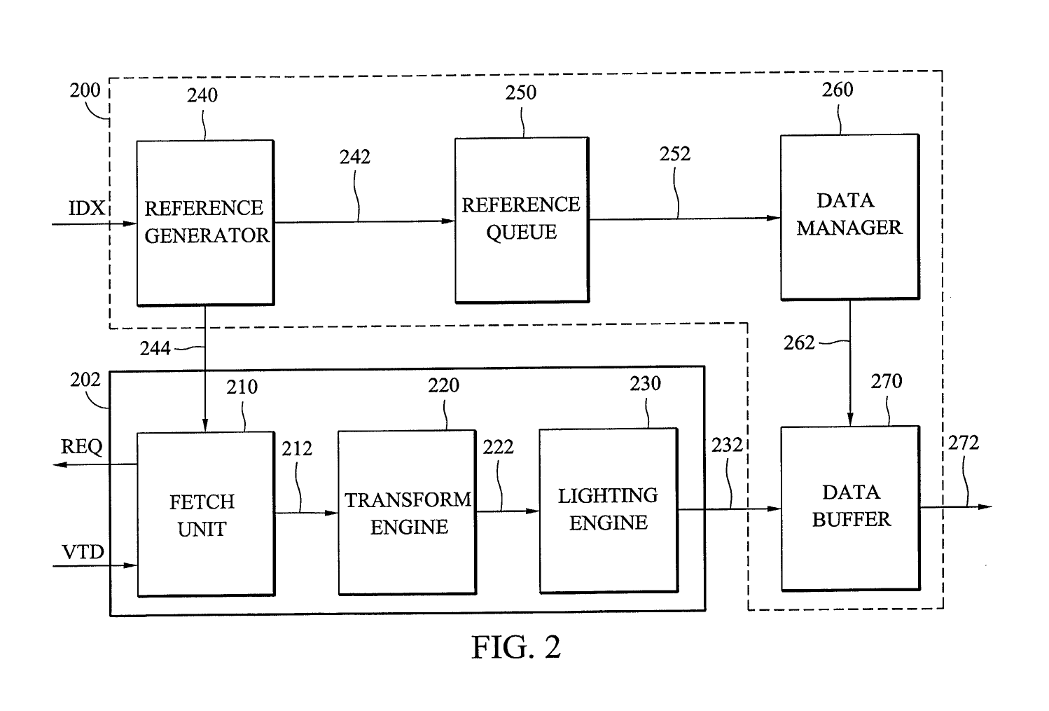

FIG. 3 is a block diagram illustrating a reference generator in accordance with a preferred embodiment of the invention;

FIG. 4 is a flowchart illustrating the primary operational steps executed by the reference generator of the invention;

FIG. 5 is a flowchart illustrating the primary operational steps executed by a data manager of the invention; and

FIGS. 6A˜6C illustrate the operation of the preferred embodiment with an example.

### DETAILED DESCRIPTION OF THE PREFERRED EMBODIMENT

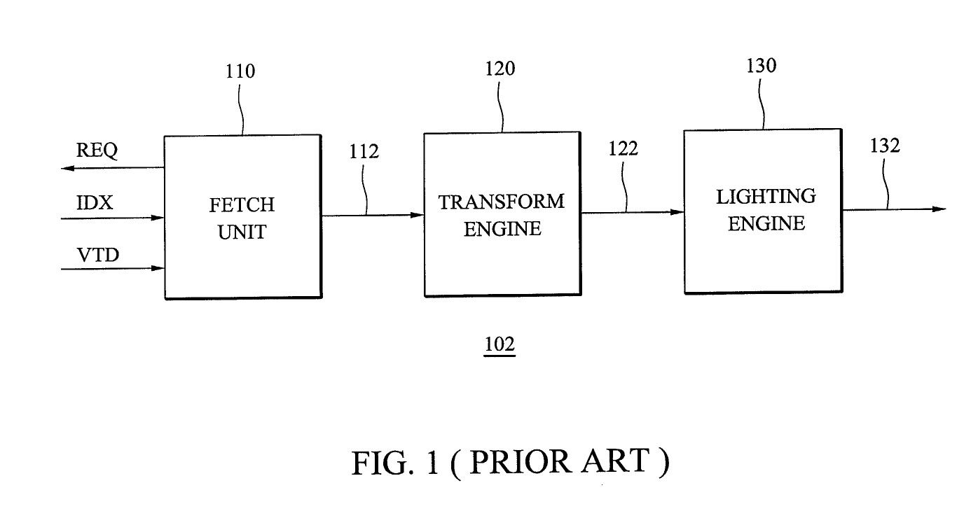

As illustrated in FIG. 1, a graphics management module 200 incorporates a geometry accelerator 202. The graphics management module 200 includes a reference generator 240, a reference queue 250, a data manager 260, and a data buffer 270. The geometry accelerator 202 has basic components including a fetch unit 210, a transform engine 220 and a lighting engine 230. By sending a data request REQ, the fetch unit 210 gets vertex data VTD according to a vertex index IDX that is received by the reference generator 240. The transform engine 220 receives the vertex data from the fetch unit 210 over bus 212 and performs transformations on the vertex data. The lighting engine 230 receives the transformed vertex data via bus 222 and calculates the final colors of the vertices of the primitives based on the vertex data and based on lighting conditions. As a result, the lighting engine 230 provides the lighted vertex data over bus 232 to the data buffer 270.

In one embodiment, the reference generator 240 receives the vertex index IDX and provides reference information having a hit value and a reference position. The reference generator 240 compares the presently received vertex index with those vertex indices that are received recently. According to the comparison, the reference generator 240 determines whether it needs to inform the fetch unit 210, via line 244, to perform vertex data access. In respect of the hit value, it indicates whether the vertex data associated with the presently received vertex index can be reused. The lighted vertex data associated with the presently received vertex index is stored in the corresponding location of the data buffer 270 in accordance with the reference position. The reference generator 240 sends the reference information to the reference queue 250 over bus 242. In this regard, the reference queue 250 is used to store the hit value and the reference position. The reference queue 250 is preferably arranged as a first-in first-out (FIFO) buffer which is useful for buffering a stream of the reference information between the reference generator 240 and the data manager 260.

The data buffer 270 is configured to store lighted vertex data processed by the geometry accelerator 202. The data manager 260 fetches the hit value and the reference position from the reference queue 250 over bus 252. In one embodiment, the data manager 260 controls the data buffer 270 via line 262. When the hit value indicates that the lighted vertex data associated with the received vertex index is previously stored in the data buffer 270, the data manager 260 instructs the data buffer 270 to directly retrieve and output the lighted vertex data according to the reference position. Otherwise, it instructs the data buffer 270 to store the lighted vertex data processed by the geometry accelerator 202 according to the reference position. The lighted vertex data is finally provided over bus 272 for further processing.

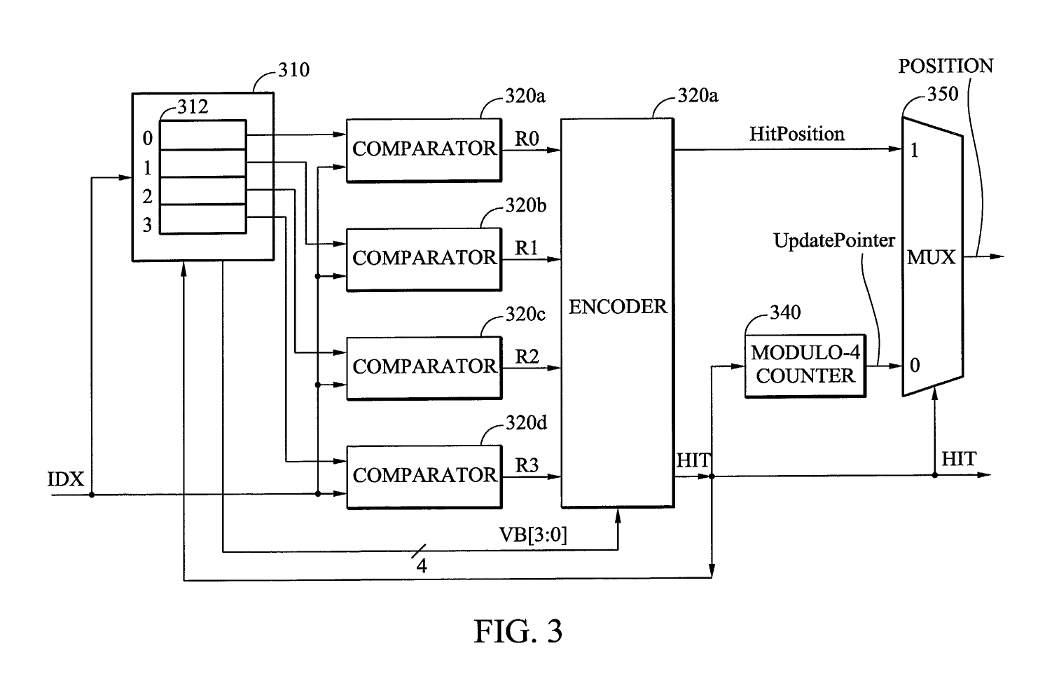

To further illustrate the reference generator 240, brief reference is made to FIG. 3. The reference generator 240 is constructed of a storage area 310, a plurality of comparators 320a˜d, an encoder 330, a counter 340 and a multiplexer 350. The storage area 310 has a plurality of entries 312. Each entry is used to store a lighted vertex index. FIG. 3 illustrates a storage area accommodating up to 4 indices. The storage area 310 is preferably arranged as a circular buffer. Note that the storage area 310 with four entries is used for illustration purpose and that one skilled in the art can apply the principles of the invention to arbitrary size. The comparators 320a˜d each compare respective content of the corresponding entry with the presently received vertex index to determine whether they are the same. In one embodiment, if the content of a certain entry and the received vertex index are the same, the corresponding output of comparator is set to logic ‘1’.

With continued reference to FIG. 3, the storage area 320 further provides four valid bits VB[3:0] to the encoder 330. Since the contents of the entries 312 are random after power-up, all of the valid bits VB[3:0] are initialized to logic ‘0’. When a vertex index is stored in an entry of the storage area 310, the corresponding valid bit is set to logic ‘1’. Providing the valid bits VB[3:0] in such a way will prevent the encoder 330 from unexpected results. In response to the comparator outputs R0˜R3, the encoder 320 is adapted to report a hit value HIT and to produce an address HitPosition. In this regard, the HitPosition is dedicated to the entry storing the lighted vertex index that is the same as the received vertex index. The table for encoding the comparator outputs R0˜R3 is given in Table 1 below, as implemented in accordance with one embodiment of the invention.

TABLE 1

| | |
|---|---|
| Encoder Output | Encoder Inputs |

| HitPosition | R3 | R2 | R1 | R0 |
|---|---|---|---|---|
| 0 | 0 | 0 | 0 | 1 |
| 1 | 0 | 0 | 1 | 0 |
| 2 | 0 | 1 | 0 | 0 |
| 3 | 1 | 0 | 0 | 0 |

The encoder 330 also performs a logical expression for the HIT. This logical expression is set forth as follows:

HIT=(R0 AND VB[0]) OR (R1 AND VB[1]) OR (R2 AND VB[2]) OR (R3 AND VB[3])

In other words, if one of the comparators 320a˜d determines that the content of the corresponding entry and the received vertex index are the same, the HIT is set active by encoder 330 to indicate a hit status.

As depicted in FIG. 3, when the HIT reported from the encoder is not indicative of the hit status, the storage area 310 stores the presently received vertex index in one of the entries 312 according to an update pointer UpdatePointer. In such a situation, the counter 340 increases the UpdatePointer by one. Preferably, the counter 340 is a modulo-N counter where N is equal to a total of the entries in the storage area 310. In response to the HIT, the multiplexer 350 outputs the HitPosition as the reference position POSITION if the HIT is indicative of the hit status. Alternatively, the multiplexer 350 outputs the UpdatPointer as the POSITION if the HIT is not indicative of the hit status.

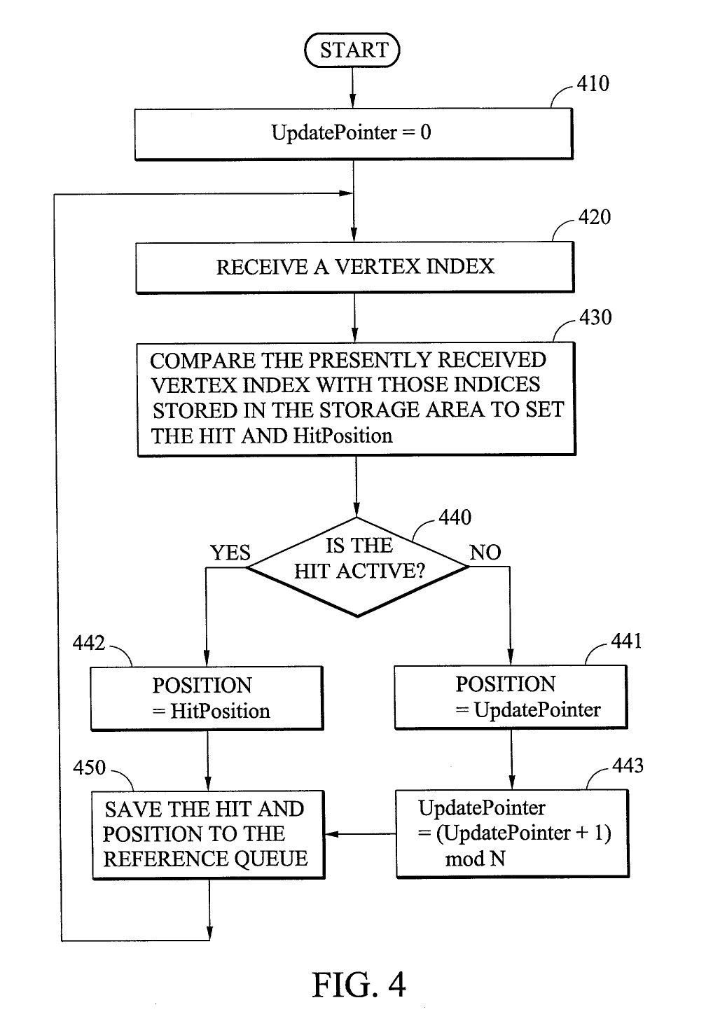

Turning now to FIG. 4, an operational flowchart of the reference generator 240 is illustrated. Broadly, the modulo-N counter 340 initializes the UpdatePointer to a value of zero after system reset or power-up (step 410). When the reference generator 240 receives a vertex index (step 420), it proceeds to step 430 where the comparators 320a˜d compare the presently received vertex index with those indices stored in the entries 312 of the storage area 310. According to the comparison, the encoder 330 sets the HitPosition and the HIT. The reference generator 240 then checks to determine whether the HIT is set active (step 440). If so, the multiplexer 350 provides the HitPosition as output the POSITION (step 442). Alternatively, the multiplexer 350 provides the UpdatePointer as output the POSITION (step 441). Thereafter, the modulo-N counter 340 increases the UpdatePointer by one (step 443). Finally, the reference generator 240 saves the reference information including the HIT and POSITION to the reference queue 250 (step 450)

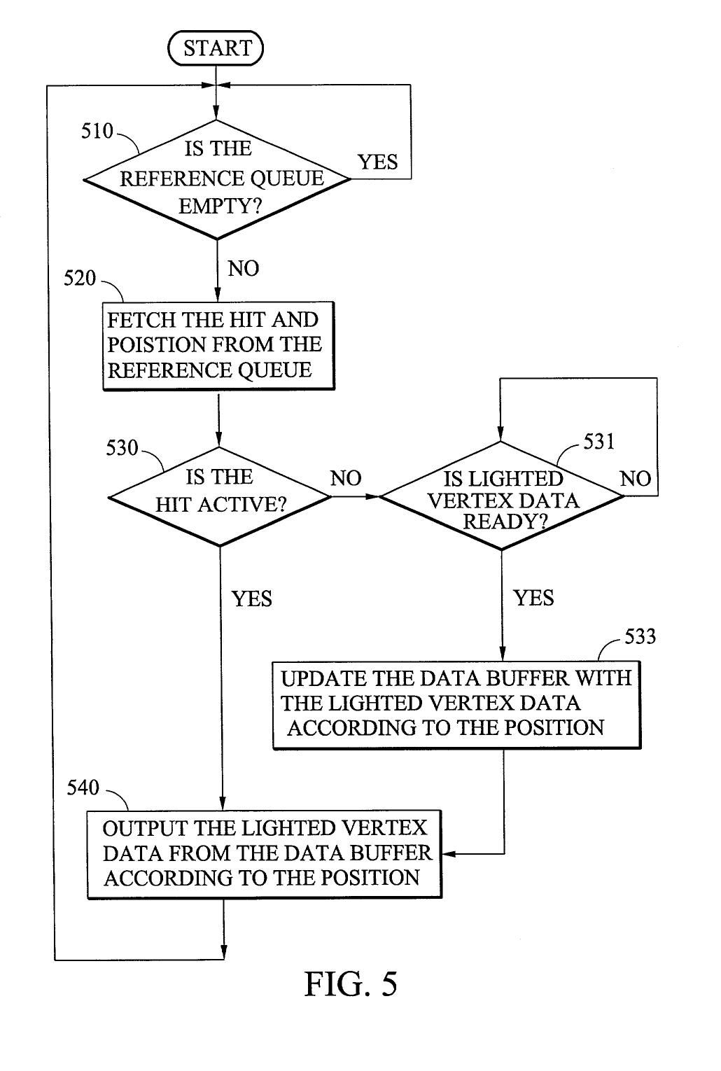

To further illustrate the operation of the data manager 260 of the invention, reference is now made to FIG. 5. First, the data manager 260 checks to determine whether the reference queue 250 is empty (step 510). If the reference queue 250 has saved the reference information, the data manager 260 fetches the reference information including the HIT and POSITION from the reference queue 250 (step 520). The data manager 260 then determines if the fetched HIT is set active (step 530). If so, the lighted vertex data is retrieved and provided from the data buffer 270 in accordance with the POSITION (step 540). Alternatively, if the fetched HIT is not active, it proceeds to step 531 where the data manager 260 looks to see whether a new lighted vertex data is ready. When the new lighted vertex data is ready, the data manager 260 updates the data buffer 270 with the new lighted vertex data according to the POSITION (step 533). Thereafter, the data manager 260 instructs the data buffer 270 to output the new lighted vertex data according to the POSITION (step 540).

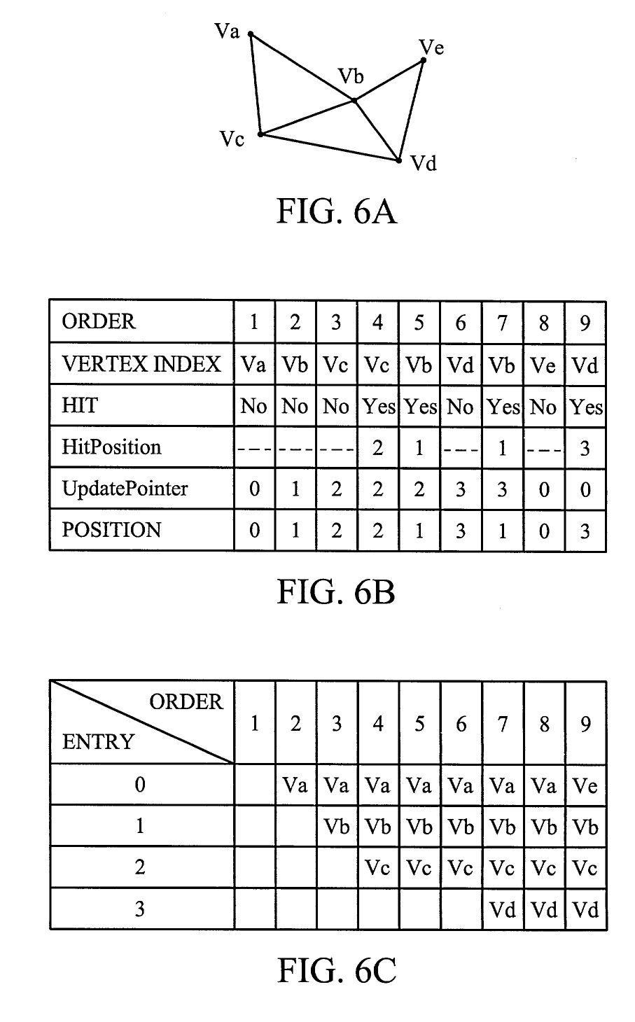

The features of the invention will be better understood with reference to FIGS. 6A˜6C. For instance, FIG. 6A shows three primitives consisting of five vertices Va, Vb, Vc, Vd and Ve. If the order of vertex indices received by the reference generator 240 is: Va, Vb, Vc, Vc, Vb, Vd, Vb, Ve, and Vd, when the reference generator 240 receives the first vertex index Va, there is no lighted vertex index in the storage area 310. Thus, the reference generator 240 reports that the HIT is not active. The reference generator 240 also provides the UpdatePointer=0 as output the POSITON. The UpdatePointer is then increased by one. As well, the second and third vertex indices Vb and Vc cannot be found in the storage area 310. When the fourth vertex index Vc is received, it is consistent with the content of entry 2 of the storage area 310. Consequently, the reference generator 240 reports that the HIT is active and provides the HitPosition=2 output as the POSITION. As discussed above, FIG. 6B shows the process of the reference generator 240 and FIG. 6C illustrates the contents of the storage area 310 within the reference generator 240. In the example of FIGS. 6A˜6C, only five vertex data are required to perform transformations and lighting calculations. In contrast, were the results of each vertex data processed directly by a conventional geometry accelerator, nine vertex data manipulations would be required.

In computer graphics, most primitives representing an object are adjacent such that these adjoining primitives have a number of common vertices. For conventional computer graphics systems, the same vertex data can be processed repeatedly. However, the operations of the geometry accelerator are computationally very intense. Processing those common vertices over and over greatly decreases the speed and efficiency by which the geometry acceleration is performed. Rather than reprocessing the common vertices time after time, the invention, instead, retrieves lighted vertex data from memory buffer, and utilizes it for further processing. Significantly, this reduces computational load in the geometry accelerator and decreases the volume of data transferred between the host computer and the computer graphics system. Therefore, tremendous time savings and increased efficiency are realized by the invention. In addition, the graphics management module according to the invention operates using relatively little circuitry. This allows the implementation of less expensive computer graphics systems, and leaves room on crowded integrated circuits for other graphics processing features.

While the invention has been described by way of example and in terms of the preferred embodiment, it is to be understood that the invention is not limited to the disclosed embodiment. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. An apparatus for reusing lighted vertex data in a computer graphics system, comprising:
a storage area having a plurality of entries each of which is used to store a lighted vertex index;
a plurality of comparators each of which compares respective content of the corresponding entry with a presently received vertex index to determine whether they are the same;
an encoder, responsive to output of the comparators, adapted to report a hit value and to produce an address, wherein the hit value is indicative of a hit status when one of the comparators determines that the content of the corresponding entry and the received vertex index are the same, and wherein the address is dedicated to the entry storing the lighted vertex index that is the same as the received vertex index;
a counter for increasing an update pointer by one when the hit value is not indicative of a hit status; and
a multiplexer, responsive to the hit value, to selectively output the address as a reference position if the hit value is indicative of the hit status, and to selectively output the update pointer as the reference position if the hit value is not indicative of the hit status.

2. The apparatus as recited in claim 1 wherein the storage area is configured to store the presently received vertex index in one of the entries according to the update pointer when the hit value reported from the encoder is not indicative of the hit status.

3. The apparatus as recited in claim 1 wherein the storage area, having the plurality of entries, is arranged as a circular buffer.

4. The apparatus as recited in claim 1 wherein the counter is a modulo-N counter where N is equal to the total number of entries in the storage area.

5. A graphics management module for use in a geometry accelerator of a computer graphics system, comprising:
a reference generator receiving a vertex index, for providing a hit value and a reference position;
a reference queue for storing the hit value and the reference position;
a data buffer for storing lighted vertex data processed by the geometry accelerator; and
a data manager fetching the hit value and the reference position from the reference queue, for instructing the data buffer to retrieve and output the lighted vertex data according to the reference position when the hit value indicates that the lighted vertex data associated with the received vertex index has been previously stored in the data buffer, and for instructing the data buffer to store the lighted vertex data processed by the geometry accelerator according to the reference position when the hit value indicates that the lighted vertex data associated with the received vertex index cannot be found in the data buffer.

6. The graphics management module as recited in claim 5 wherein the received vertex index is a lighted vertex index dedicated to the lighted vertex data that has been processed by the geometry accelerator, if the hit value indicates that the lighted vertex data associated with the received vertex index cannot be found in the data buffer.

7. The graphics management module as recited in claim 6 wherein the reference generator comprises:
a storage area having a plurality of entries each of which is used to store the lighted vertex index;
a plurality of comparators each of which compares respective content of the corresponding entry with the received vertex index to determine whether they are the same;
an encoder, responsive to output of the comparators, adapted to report the hit value and to produce an address, wherein the hit value is indicative of a hit status when one of the comparators determines that the content of the corresponding entry and the received vertex index are the same, and wherein the address is dedicated to the entry storing the lighted vertex index that is the same as the received vertex index;
a counter for increasing an update pointer by one when the hit value is not indicative of a hit status; and
a multiplexer, responsive to the hit value, to selectively output the address as the reference position if the hit value is indicative of the hit status, and to selectively output the update pointer as the reference position if the hit value is not indicative of the hit status.

8. The graphics management module as recited in claim 7 wherein the hit value indicates the hit status if the lighted vertex data associated with the received vertex index is previously stored in the data buffer.

9. The graphics management module as recited in claim 7 wherein the storage area is configured to store the received vertex index in one of the entries according to the update pointer when the hit value reported from the encoder is not indicative of the hit status.

10. The graphics management module as recited in claim 7 wherein the storage area, having the plurality of entries, is arranged as a circular buffer.

11. The graphics management module as recited in claim 7 wherein the counter is a modulo-N counter where N is equal to a total of the entries in the storage area.

12. The graphics management module as recited in claim 5 wherein the reference queue is arranged as a first-in first-out (FIFO) buffer.
